(19) United States
(12) Patent Application Publication
(10) Pub. No.: US 2025/0070858 A1
(43) Pub. Date: Feb. 27, 2025

(54) METHOD AND SYSTEM TO SPEED UP SATELLITE ACQUISITION IN NON-TERRESTRIAL NETWORKS VIA ALMANAC INFORMATION

(71) Applicant: Samsung Electronics Co., Ltd., Gyeonggi-do (KR)

(72) Inventor: Raul Hernan ETKIN, Sunnyvale, CA (US)

(21) Appl. No.: 18/508,862

(22) Filed: Nov. 14, 2023

Related U.S. Application Data
(60) Provisional application No. 63/520,719, filed on Aug. 21, 2023.

(51) Int. Cl. H04B 7/185; H04W 48/16

(52) U.S. Cl. CPC H04B 7/18513; H04W 48/16

(57) ABSTRACT

A system and a method are disclosed for improving cell searching in a non-terrestrial network (NTN), the method including obtaining almanac information, obtaining position, velocity or time (PVT) information, and generating a list of one or more satellites in view based on the almanac information and the PVT information.

### CROSS-REFERENCE TO RELATED APPLICATION

This application claims the priority benefit under 35 U.S.C. § 119 (e) of U.S. Provisional Application No. 63/520,719, filed on Aug. 21, 2023, the disclosure of which is incorporated by reference in its entirety as if fully set forth herein.

### TECHNICAL FIELD

The disclosure generally relates to wireless communication. More particularly, the subject matter disclosed herein relates to improvements to cell searching in non-terrestrial networks (NTNs).

### SUMMARY

Cell searching is a procedure in NTN communication systems to establish initial links between user devices and satellites. However, the conventional cell search process faces certain challenges that limit its efficiency and performance.

For example, the cell search process involves searching for and acquiring synchronization with a specific satellite among a large number of potential satellite candidates. This process requires significant computational resources, as it involves complex calculations and searching algorithms.

In NTN systems, satellites can move at very high speeds, resulting in large Doppler shifts of the transmitted signals as observed from the user devices on the ground. A Doppler shift may refer to a phenomenon characterized by the alteration in the frequency or wavelength of waves, such as sound or electromagnetic waves, resulting from relative motion between a source emitting these waves (e.g., a satellite) and an observer or receptor (e.g., a user equipment (UE)). This shift in frequency or wavelength can manifest as an increase (positive Doppler shift) or decrease (negative Doppler shift) depending on whether the source is approaching or moving away from the observer, respectively. Without prior knowledge of satellite orbits, the cell search process needs to contend with greater frequency uncertainty caused by the unknown Doppler shift. This increased frequency uncertainty not only adds to the computational burden but also potentially leads to longer acquisition times.

In addition, a cell search process traditionally involves searching for satellites even in situations where they may not be in the line of sight of the UE at a given position and time. This inefficient utilization of searching resources can contribute to longer acquisition times and suboptimal network efficiency.

To overcome these issues, systems and methods are described herein for reducing the complexity of the cell search process in NTN systems by leveraging almanac information. Almanac information may refer to data specific to each satellite constellation that assists receivers (e.g., global positioning system (GPS) and/or NTN satellites) in determining their position and/or synchronizing their internal clocks. Satellites for NTN may differ from those used for global navigation satellite system (GNSS). The almanac information may provide a coarse representation of satellite orbits and can be utilized in conjunction with the knowledge of the UE's location obtained through GNSS or other geo-location technologies.

By using the almanac information, the UE can determine which satellites are in view at its specific location and obtain an approximate estimate of the Doppler shift they experience. This information may then be utilized to generate a reduced and prioritized search space during the cell search procedure.

The reduced search space can be designed to prioritize the frequencies that are more likely to occur based on the estimated Doppler shift. By searching for these prioritized frequencies first, the cell search process becomes more efficient, as it focuses on the most probable signal sources. This approach speeds up the acquisition process and can also enhance cell search sensitivity, enabling faster and more reliable synchronization between the UE and the targeted satellite.

By utilizing almanac information and applying a reduced and prioritized search space based on estimated Doppler shifts, the proposed solution optimizes resource utilization, reduces computational burden, and improves the overall efficiency and performance of the cell search process.

In an embodiment, a method for improving cell searching in an NTN comprises obtaining almanac information, obtaining position, velocity or time (PVT) information, generating a list of one or more satellites in view based on the almanac information and the PVT information.

In an embodiment, an electronic device comprises a non-transitory storage device storing instructions, and a processor configured to execute the instructions, causing the electronic device to obtain almanac information, obtain PVT information, generate a list of one or more satellites in view based on the almanac information and the PVT information.

### BRIEF DESCRIPTION OF THE DRAWING

In the following section, the aspects of the subject matter disclosed herein will be described with reference to exemplary embodiments illustrated in the figures, in which:

FIG. 1 illustrates a representative network environment architecture, according to an embodiment;

FIG. 2 illustrates a network environment giving rise to a Doppler shift, according to an embodiment;

FIG. 3 illustrates a flowchart for building an ordered list for identifying a satellite, according to an embodiment; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

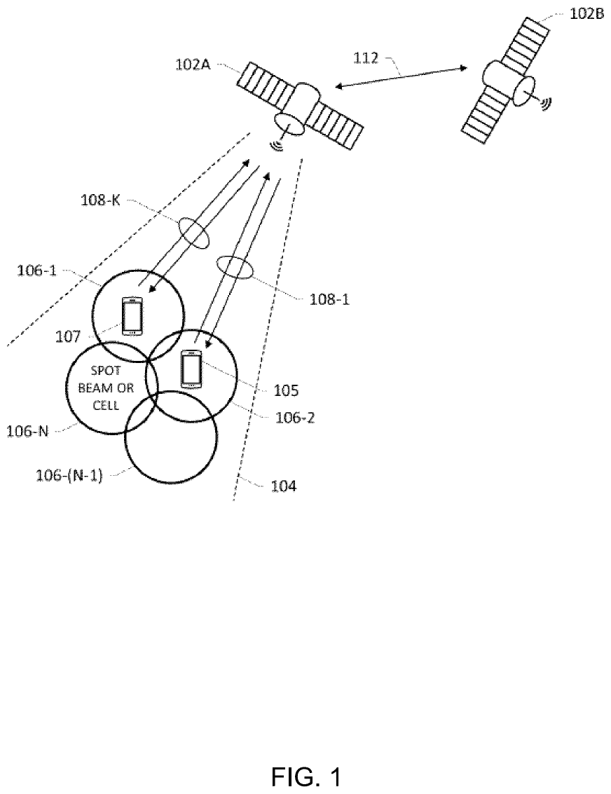

FIG. 1 illustrates a representative network environment architecture, according to an embodiment.

The environment of FIG. 1 may represent a framework within which various embodiments of the patent disclosure at hand can be applied, as outlined in the following explanation.

Those of ordinary skill in the art will also discern from this reference that some example embodiments of the current disclosure can be implemented within an NTN architecture featuring equipment beyond just satellites. This broader scope includes airborne or spaceborne vehicles designed for communication purposes. These vehicles can encompass high-altitude platform stations (HAPS), low-altitude platform stations (LAPS), whether tethered or untethered, unmanned aircraft systems (UAS), unmanned aerial vehicles (UAV), drones, and similar entities operating at altitudes lower than the conventional satellite deployments. The specific choice of equipment may depend on factors like implementation, spectrum allocation, and service coverage.

In cases where mobile cellular or wireless communication networks are integrated with a representative NTN architecture, these networks can include infrastructure drawn from various sources, including but not limited to global system for mobile communication (GSM) radio access network (GRAN) infrastructure, enhanced data rates for global system for mobile communications (GSM) evolution (EDGE) network (GERAN) infrastructure, 3rd/4th/5th Generation Partnership Project (3/4/5GPP) network infrastructure (including 5G New Radio (NR)), integrated digital enhanced network (IDEN) infrastructure, heterogeneous access network (HAN) infrastructure, code division multiple access (CDMA) network infrastructure, universal mobile telecommunications system (UMTS) network infrastructure, universal terrestrial radio access network (UTRAN) infrastructure, long term evolution (LTE) infrastructure, and various types of Institute of Electrical and Electronics Engineers (IEEE) 802.11 class wireless fidelity (WiFi) communications infrastructure.

Referring to FIG. 1, a satellite is shown in a first position 102A and a second position 102B and moves along path 112. Additional satellites may also be included, and may encompass a wide range of communications satellites orbiting Earth. These satellites may be organized into one or more constellations to provide global, national, supra-national, or regional coverage for numerous subscribers across various services. These services can include, but are not limited to, satellite communications (SATCOM) involving voice, data, text, video, and internet connectivity, as well as land mobile satellite services, maritime mobile satellite services, multimedia broadcast services, navigation services, global positioning, and more. Depending on the implementation, these satellites may be positioned at different altitudes within various Earth orbits to ensure optimal service coverage across diverse geographic areas.

In some representative scenarios, satellites may orbit Earth in a geosynchronous (GSO) or geostationary earth orbit (GEO). In other instances, they may occupy a medium earth orbit (MEO) that is closer to Earth's surface than GSO or GEO. Furthermore, the satellites may be positioned in even closer orbits, such as a low earth orbit (LEO).

Satellites in MEO or LEO orbits move across the sky more rapidly than those in GEO orbits. Consequently, in MEO or LEO configurations, satellites do not remain continuously visible in the sky from a fixed point on Earth, such as a satellite service user (e.g., a UE) or a ground station. Instead, they appear to cross the sky and “disappear” when they pass behind Earth's surface (i.e., the horizon). To maintain uninterrupted communication capabilities in such cases, a larger number of satellites in LEO/MEO orbits may be necessary, ensuring that at least one satellite is always within a visible line of sight for transmitting and receiving communication signals, including control signals and user data signals, to and from users equipped with suitable UEs or terminals, such as UE 105 and UE 107.

Satellites, such as spaceborne or airborne platforms, incorporate specialized equipment and interconnect architecture to support various aspects of satellite operations. This equipment includes systems for power management, thermal control, altitude control, and communication payloads, which encompass antennas and transponders. In some embodiments, these satellites are designed to operate across a wide range of radio and microwave frequencies to relay communication signals over Earth's curvature, enabling communication between widely separated geographical locations or regions. To optimize spectrum utilization and mitigate signal interference, satellite communications can be conducted in multiple frequency bands using suitable protocols, including 3GPP protocols like 5G NR, especially when adapted to accommodate the NTN infrastructure, as elaborated further below.

Regardless of whether non-3GPP or 3GPP radio protocols are employed for NTN communications, a typical satellite can generate one or more beams that cover a specific geographical area, referred to as a footprint or service coverage area. When multiple beams are generated within a service coverage area, each beam, also known as a spot beam, encompasses a ground area. This ground area can be conceptualized as a satellite cell or spot beam cell. The footprint of a spot beam (and hence the overall service coverage area) may change as the satellite moves in some deployments, while in other arrangements, the footprint remains fixed, and onboard mechanisms compensate for the satellite's motion.

In general, the distance of a satellite's orbit from Earth has an inverse relationship with signal strength and a positive relationship with the service coverage area or footprint. Therefore, the size of a spot beam depends on the system design and orbital deployment. Notably, the coverage of a GEO satellite can be extensive but static, requiring only infrequent updates of spot beam pointing directions to account for the satellite's movement. In contrast, the movements of non-GEO satellites, particularly LEO satellites, lead to varying coverage in both time and space. For instance, a typical LEO satellite may only be visible to a ground UE for a few minutes, implying that even in an LEO satellite communications system with Earth-fixed beams, the serving satellites may change every few minutes. These variations in coverage have implications for UE mobility management methods when adapting 5G NR for non-GEO satellite communications, potentially necessitating frequent positioning updates, as further detailed below.

To illustrate, satellite 102A operates to provide coverage over an area labeled as 104, which includes numerous spot beam cells 106-1 to 106-N, some of which may overlap. Within these cells, one or more users equipped with corresponding UE terminals 105 and 107 may be located. For NTN communications, one or more transponders on satellite 102A can establish service links (also known as access links) labeled as 108-1 to 108-K between the satellite and respective UE terminals 105 and 107.

Doppler shifts in NTN networks are a consequence of relative motion between satellites and UEs. These shifts impact both uplink (UL) and downlink (DL) communications. According to the some 3GPP NTN protocols, UEs are required to pre-compensate for the Doppler shift in UL transmissions to ensure accurate communication with satellites. However, this requirement may vary in non-3GPP protocols or future versions of 3GPP protocols. In the DL, challenges arise during cell search and frequency tracking due to the Doppler shift, which can introduce variations in the received signal's frequency as the UE and satellite move relative to each other. Effective management of Doppler shifts is essential for maintaining reliable and stable connections in NTN networks, especially in mobile scenarios.

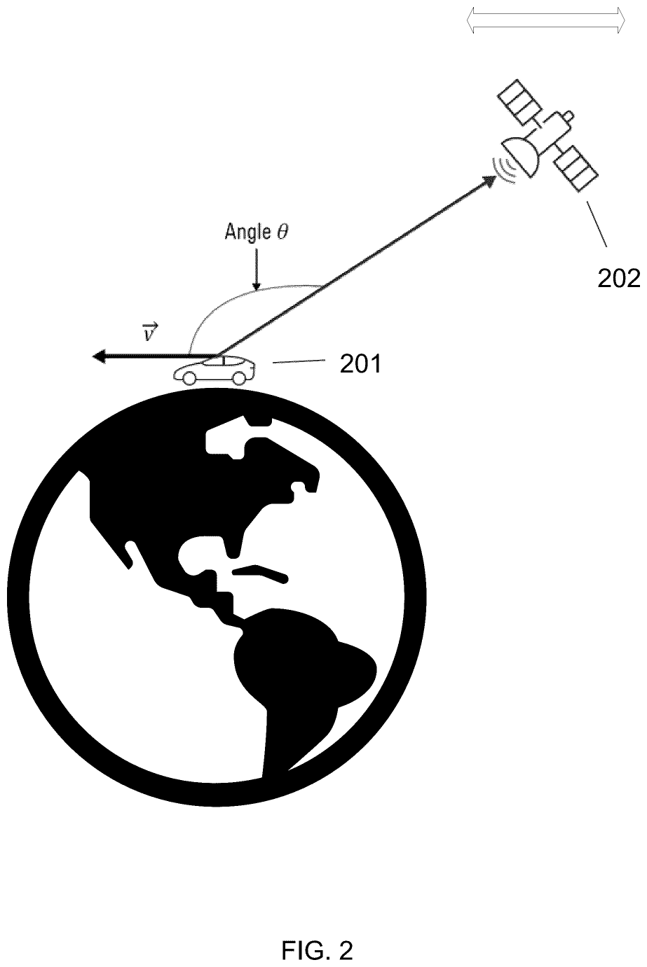

FIG. 2 illustrates a network environment giving rise to a Doppler shift, according to an embodiment.

Referring to FIG. 2, UE 201 is illustrated as a vehicle. It is noted that the UE 201 should not be limited to a vehicle, and may also include other electronic devices, such as terminals, cellular telephones, computers, and/or tablets. The UE 201 may correspond to the UEs 105 and/or 107 of FIG. 1.

The effects of a doppler shift may become evident when the motion of the UE 201 with respect to the Earth differs from the motion of the satellite 202 with respect to the Earth. In the case of LEO satellites, the largest component of the Doppler shift tends to be the satellite's velocity. Doppler shift may cause an unwanted change in the frequency of the received signal compared to the transmitted signal. When a source is moving away from an observer, it leads to a negative Doppler shift (lower frequency), while approaching motion results in a positive Doppler shift (higher frequency). These frequency shifts can alter the received signal, which may affect the acquisition process of the UE.

The acquisition process may refer to when the user device attempts to establish a connection with a satellite or a satellite network. This process may include several steps to synchronize and align the receiver in the user device with the signal being transmitted by the satellite, such as searching for a satellite signal by scanning a wide range of frequencies to recognize signals from satellites.

The present disclosure contrasts with methods typically used in GNSS applications. In the context of the present disclosure, it is assumed that the PVT information of the UE is already known. In a typical GNSS application, the UE PVT information is not known in advance, as the purpose of GNSS is to determine that information. Consequently, the use of almanac information in GNSS applications is usually limited to determining information pertaining to the satellites in view.

However, in the present disclosure, it is assumed that the GNSS has already provided the UE with PVT information. This information is then utilized to expedite the acquisition process by determining the Doppler shift of the signals, in addition to assessing the satellite visibility.

Other methods for Doppler pre-compensation, which rely on the GNSS position and satellite ephemeris, require the knowledge of satellite ephemeris. Satellite ephemeris (e.g., ephemeris information), such as Keplerian parameters, provides precise satellite position and velocity information, but only for a short timeframe called the ephemeris validity window. This data accounts for deviations from the ideal orbital path, enhancing accuracy but limiting its timeframe of relevance.

On the other hand, almanac information represents the “average” satellite orbit without detailing minor deviations. While less accurate compared to fresh (e.g., recently acquired) ephemeris data, the almanac information extends its validity over a much longer period. The almanac information offers coarse satellite position and velocity estimates, valuable for assessing satellite visibility or calculating the Doppler shift experienced by signals received at a known Earth location.

Typically, the NTN satellite ephemeris is not provided by GNSS. While GNSS information could be available before, during, or after the cell search phase, the method disclosed herein may not be able to be utilized during the initial cell search process.

To address this limitation, the present disclosure provides a novel approach for generating approximate satellite orbital information via almanac information including prior ephemerides downloads. These downloads can be utilized in future cell searches to speed up and simplify satellite acquisition.

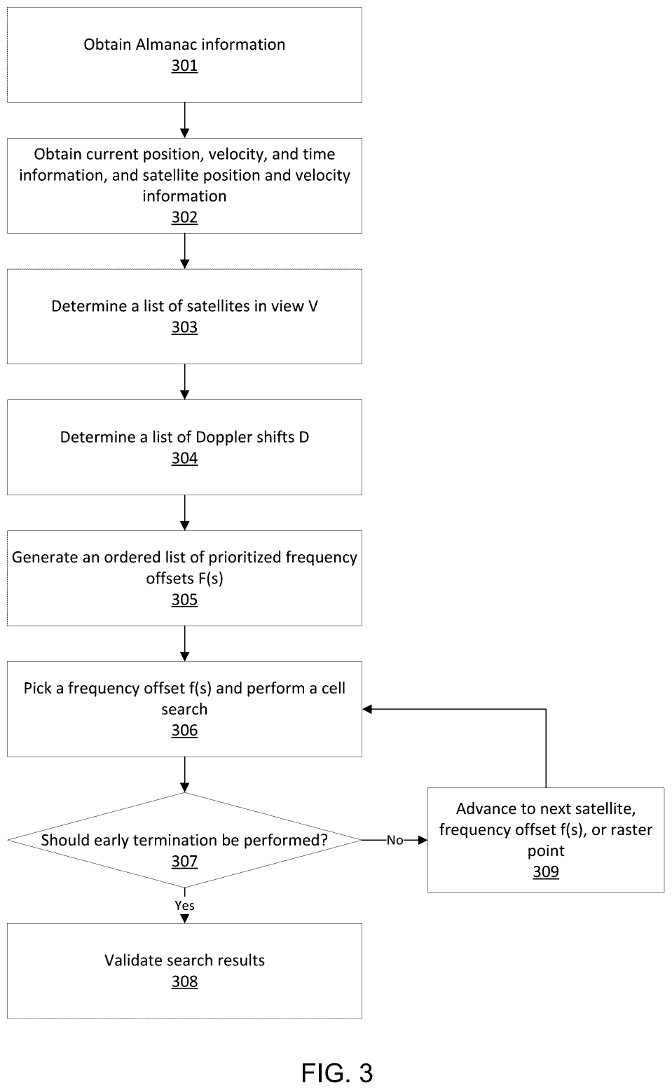

FIG. 3 illustrates a flowchart for building an ordered list for identifying a satellite, according to an embodiment. FIG. 3 may be performed by an electronic device, such as a UE (e.g., a terminal), a satellite, or any other network device including a controller (e.g., a processor).

Referring to FIG. 3, in step 301, the electronic device (e.g., the UE) obtains almanac information. For example, the electronic device may download the almanac information when operating in an NTN satellite communication system.

In this step, the UE may take advantage of its network connectivity, which can be via cellular networks, NTN, WiFi, or similar means, to acquire almanac information specific to the NTN satellite constellation it intends to communicate with. This almanac information may include information about the coarse orbital parameters of the satellites within the constellation.

The source of this almanac information can be the satellite operator itself or any other service or entity that tracks the movements and positions of these satellites. This data can be represented in various formats, with the two-line element set (TLE) format being one example, allowing for the representation of orbital parameters as American Standard Code for Information Interchange (ASCII) text.

The downloaded almanac information may include a validity period, indicating a timeframe during which the almanac information remains accurate. This temporal aspect may be necessary for determining satellite locations, as satellite positions change over time due to their orbital paths.

The UE may store the almanac information in its local memory. To ensure the information persists even after device resets, the almanac information may be stored in non-volatile memory.

Almanac information updates can be actively requested by the UE (polled) or pushed from a network device (e.g., a server). The frequency of these updates should strike a balance between factors like network usage, power consumption, connectivity costs, the almanac information's validity period, and the trade-off between accuracy loss over time and the increased search time if outdated almanac information requires searching for more synchronization hypotheses.

A synchronization hypothesis refers to a proposed set of parameters, variables, or configurations determined by a UE that are used to synchronize and communicate with a wireless device, such as a satellite, to establish a connection with an NTN satellite. The synchronization hypothesis may be used to generate a locally produced copy of the expected incoming signal. This local signal may be used for correlation with the actual incoming signal to detect and synchronize with the signal source (e.g., a satellite).

In an alternative embodiment, a UE may determine a synchronization hypothesis to communicate with another UE. However, in this case, the satellite orbit may be irrelevant (e.g., almanac information and/or ephemeris data may not be necessary).

The almanac information may encompass data about all the satellites the UE might potentially connect to, or it could be a subset of these satellites. In scenarios where the UE can connect to satellites from different operators, it may need to download almanac information from each relevant operator. Throughout the patent application, the term “almanac information” is used to collectively refer to all available almanac information accessible to the UE.

In some cases, almanac information may not be available to the UE. The UE may derive the almanac information (e.g., TLE or an equivalent representation) by utilizing ephemeris data obtained from the satellite. This process may involve removing higher-order parameters in the orbital model. As the UE establishes connections with different satellites within the constellation, it gradually accumulates coarse orbital details for the satellites commonly visible from its location. This accumulation of knowledge enables the UE to expedite the re-acquisition or cell search process for those satellites in subsequent instances by leveraging the learned coarse orbital parameters.

For example, the UE may generate coarse orbital information by “averaging” the ephemeris information it obtains from a satellite(s) over time. That is, as part of normal NTN operations, the UE downloads and uses the satellite ephemeris. Instead of discarding the ephemeris when its validity time expires, the UE can use the ephemeris together with previously downloaded ephemerides to generate “average” orbital information for the given satellite. In this way, the UE can learn over time approximate almanac information without requiring external almanac information to be downloaded from the network, and use this almanac information to obtain position and velocity information.

In step 302, the electronic device (e.g., the UE) obtains current position, velocity, and time (PVT) information, and satellite position and velocity information.

The electronic device may be required to acquire GNSS information based on 3GPP standards for NTN. GNSS information may include PVT data. Additionally, it may include an estimate of the local oscillator (LO) frequency offset (FO), although this FO data may not be required to perform the proposed solution.

The PVT data may include details about the UE's current position, velocity, and accurate time synchronization. This information may be used for precise satellite synchronization and communication.

Position information can be expressed in various global coordinate systems, such as latitude, longitude, and altitude (LLA) or Earth-centered, Earth-fixed (ECEF) coordinates. Velocity data can be represented in a global coordinate system like ECEF or in a local coordinate system like North-East-down (NED). Time information can be provided in terms of GPS time or coordinated Universal time coordinates (UTC). Conversion between different coordinate systems can be achieved using standard transformation methods.

Satellite position and velocity information can be obtained from the almanac information. By combining the PVT information obtained from the GNSS system with the almanac information acquired in step 301, the UE may gain the capability to determine the real-time velocities and line-of-sight directions of each satellite xₛ in the satellite constellation. These are required to make the Doppler shift determination (step 304, below). Accordingly, the UE PVT information may be needed to compute the Doppler shift in step 304.

The specific process for deriving these positions and/or velocities from the almanac information depends on the format in which the almanac information is provided. For instance, if the almanac information is furnished in the TLE format, the UE can employ models and algorithms like simplified general perturbations 4 (SGP4).

In step 303, the electronic device (e.g., the UE) determines a list of satellites S in view V.

S represents the satellites within the given satellite constellation. A satellite constellation might encompass satellites in various orbital configurations or even satellites that originate from different satellite operators.

To determine which satellites are currently visible to the UE, Equation (1) may be used to calculate to a satellite elevation angle α as follows:

$$α = {sin}^{- 1} \sqrt{\frac{{x}^{2} - {R}_{E}^{2} ( 1 + {γ}^{2} )}{2 γ {R}_{E}^{2}}} \qquad ( 1 )$$

where x=|xᵤ−xₛ| is the distance from the UE to the satellite at a given time, and γ=(R_{E}+h)/R_{E} (obtained from Earth's radius R_{E} and the satellite orbit's height h).

To make practical determinations based on the calculated elevation angle α, an elevation mask M may be established. This elevation mask M may be based on the UE's sensitivity and other relevant constellation-specific parameters. Additionally, the age of the almanac information may be factored in, introducing a level of uncertainty into the satellite elevation calculations.

Accordingly, a satellite may be determined to be “in view” at a given time if its calculated elevation angle α is greater than the predefined elevation mask M.

The outcome of step 303 is the formation of a list known as V, which includes the satellites currently within the user's line of sight (“in view”). In mathematical terms, this can be represented according to Equation (2):

$$V = \{ s ∈ S : α ( s ) > M \} \qquad ( 2 )$$

Thus, V may represent the set of satellites that are visible and accessible to the UE at the specific time, considering factors like the satellite's orbital positions, the Earth's geometry, and the UE's sensitivity.

In step 304, the electronic device (e.g., the UE) determines a list of Doppler shifts D.

For each satellite s∈V, having UE PVT and the satellite position and velocity obtained in step 302, the Doppler shift d(s) can be determined. D may be defined as the set of Doppler shifts d(s) for the satellites in view V based on Equation (3):

$$D = \{ d ( s ) : s ∈ V \} \qquad ( 3 )$$

In step 305, the electronic device generates an ordered list of prioritized frequency offsets F(s). This prioritized frequency list may include one or more transmission frequencies to be searched. The one or more transmission frequencies are defined below, and may include individual frequencies and/or subsets of frequency bands within one or more given frequency range(s).

The cell search process involves selecting frequency offsets Δf₀ to cover a specific range of frequency offsets that should be explored during the search for acquiring a satellite. The choice of the parameter Δf₀ is a tradeoff between search sensitivity and search time. When Δf₀ is smaller, the signal-to-noise ratio (SNR) loss at the closest search step to the actual received frequency is reduced on average. However, a smaller Δf₀ implies that more frequency steps (a number of search hypotheses) are required to account for the frequency uncertainty. The selection of Δf₀ may also depend on the subcarrier spacing (SCS), which is a characteristic of the communication system. The solution proposed in this context has the potential to reduce Δf₀, increasing sensitivity.

In addition to Δf₀, the search process may consider prior knowledge regarding the LO frequency uncertainty FOₘₐₓ, and the maximum Doppler shift f_{d,max}. The elevation angle α may be set to the minimum feasible elevation based on a type of satellite. This elevation angle is represented as M in the step 304.

The search process defines an ordered list of prioritized frequency offsets for each satellite s based on Equations (4)-(6), shown below:

$${F}^{′} ( s ) = \{ d ( s ) , d ( s ) + Δ {f}_{0} , d ( s ) + 2 Δ {f}_{0} , d ( s ) - 2 Δ {f}_{0} , … , d ( s ) + n Δ {f}_{0} , d ( s ) - n Δ {f}_{0} \} \qquad ( 4 )$$

$${F}^{″} ( s ) = \{ f ∈ {F}^{′} ( s ) : \vert f \vert < {f}_{d , max} + {FO}_{max} \} \qquad ( 5 )$$

$$F ( s ) = {F}^{″} ( s ) \backslash {⋃}_{k = 1}^{s - 1} {F}^{″} ( k ) \qquad ( 6 )$$

where “\” denotes a set difference and n is chosen based on the uncertainty of the estimated Doppler shift and LO FO uncertainty. In one instance, with fresh almanac information (e.g., when a time elapsed since obtaining a prior set of almanac information is less than a predetermined time period or duration) and an accurate estimate of the LO FO (e.g., obtained from GNSS), n=0. However, in another instance, with no almanac information or very old almanac information (e.g., when a time elapsed since obtaining a prior set of almanac information is greater than or equal to a predetermined time period or duration) and no prior information on the LO FO, one may choose n=(f_{d,max}+FOₘₐₓ)/Δf₀. n may also be adaptive. For example, n may be reduced if satellites are recently found early in the search process, and n can be enlarged when the recent searches resulted in failure or success near the end of the prioritized search list.

It is possible that the ordered lists F″(s) have repeated entries across various satellites s. That is, it is possible that F″(sᵢ)∩F″(sⱼ)≠Ø for some i≠j. In this case, in order to avoid searching over the same frequency multiple times the set difference operation shown above in Equation (6) may be used.

Additionally or alternatively, the ordered list of frequencies generated in step 305 may include frequencies spanning the full frequency uncertainty range, which includes all possible Doppler shifts and the LO frequency uncertainty. The ordered list can be reduced in size as a function of the age of the almanac information and the associated uncertainty of the predictions that can be made at the present time. In one instance, with fresh almanac information, the list may include only a few entries corresponding to the current estimate of the Doppler shift and a few steps Δf₀ around it to account for the LO uncertainty and any small uncertainty of the Doppler shift estimate. On the hand, with older Almanac information, the list may fall back to the full list F(s).

In step 306, the electronic device (e.g., the UE) picks a frequency offset f(s) and performs a cell search. The frequency offset f(s) may be based on an offset caused by the doppler shift d(s) and a frequency from a synchronization raster, which is defined below. In step 307 the electronic device (e.g., the UE) determines whether early termination should be performed. Early termination of a cell search or synchronization process should be performed when certain criteria are met, indicating that it is highly likely that a valid synchronization signal has been found. Early termination is implemented to save computational resources and time when a clear and strong indication of synchronization is observed.

To determine if early termination should be performed in step 307, the cell search process begins in step 306 by searching for synchronization signals in the synchronization rasters R. These rasters R represent predefined frequency points where synchronization signals are expected to be present. The set R includes these synchronization raster frequencies to be searched over. R may encompass synchronization rasters for various frequency bands and SCSs. These rasters R may be organized as an ordered list, with priority given by the operator or based on likelihood factors, such as band or SCS characteristics or specific frequencies.

For instance, searching one or more transmission frequencies may be defined as follows: searching a generic set of frequencies that spans across multiple bands and/or SCSs. As an example, if searching for signals with a 15 kHz SCS, a specific set of frequencies (e.g., designated as R) can be searched. However, if search parameters shift to a satellite transmitting with a 30 kHz SCS, adjusting and referring to another set of frequencies within R may be necessary.

To enhance flexibility and adaptability, R can be tailored to each satellite within the constellation. Satellite operators may provide lists of raster frequencies specific to individual satellites. Furthermore, the system can be further refined to allow location-dependent rasters. In this scenario, satellite operators can furnish lists of raster frequencies based on geographic regions, ensuring efficient synchronization search in diverse areas.

The cell search process involves computing correlations between the received signal and local copies of synchronization sequences (e.g., a hypothesis being evaluated). These sequences, which may include primary synchronization sequences (PSS) and secondary synchronization sequences (SSS), serve as reference signals. The routine sets parameters associated with the hypothesis being evaluated. These parameters include, for example, frequency, time offset, and cell identification. These parameters are initially unknown to the UE. The correlation value generated through this process serves as an indicator of the likelihood that the current hypothesis is correct. The search process (e.g., the result of comparing the incoming signal with the local copy (generated based on a particular hypothesis)) determines a correlation value. The value obtained from the correlation provides a metric that indicates how well the incoming signal matched the local copy.

As the search proceeds, a list L is generated containing the top N correlation values along with associated search parameters. This list L effectively tracks the most promising hypotheses in terms of signal synchronization. The list L (also referred to as a “correlation list”) may include a list of correlation values ordered from a highest correlation value to a lowest correlation value.

To optimize resource usage and minimize unnecessary processing, an early termination block is employed. This block evaluates the hypotheses within list L to determine if any of them are highly likely to be correct. This determination can involve secondary correlations with other synchronization signals. Also, the search may determine whether a correlation value is equal to or greater than a threshold. In addition, the search may determine whether a correlation ratio among satellites in the list L is equal to or greater than a threshold. For example, a ratio of the value of a top (or highest) correlation value in the list L may be compared to a correlation metric function (e.g., an average) of one or more of the correlation values in the list L (e.g., the second highest correlation value in the list L) or all correlation values in the list L besides the highest correlation value in the list L. The threshold used for comparing the correlation ratio among the satellites in the list L may be a different type of threshold with a different value than the threshold used for comparing the correlation value of the one or more satellites in the list L. Additionally, the search may attempt data decoding and redundancy checks, leveraging features like checking parity information, and/or computing and comparing cyclic redundancy checks (CRC) or other error detection properties present in a structure of the encoded data stream (e.g., based on parameters such as time, frequency, cell ID). The “structure” of the encoded data stream may be defined by its organized format after being processed for transmission. It encompasses elements like preambles, error-correcting codes, and modulation techniques. This organization helps receivers correctly interpret and recover transmitted data, differentiating intentional signals from random interference and noise.

If the early termination determination step 307 confirms a highly likely correct hypothesis within list L, that hypothesis is used as the result of the search. Moreover, to conserve resources, the routine may validate the search results in step 308 and halt further searches over hypotheses within R and F, thereby preventing unnecessary computations. The search process may be resumed later to track new satellites as the current ones fall out of view or to find secondary service cells.

Alternatively, if a current hypothesis being evaluated isn't a suitable hypothesis, then early termination shouldn't be performed, and the method may advance to the next satellite s, frequency offset f(s), or raster point r in step 309, and then continue performing a cell search based on step 306, above.

Furthermore, as time passes and more data is received, the correlations identified during searching may involve accumulations over multiple instances of the synchronization sequences. Multiple accumulations allow increasing the sensitivity of the detection process. When multiple accumulations are possible, it may be desirable to interrupt the search and have it restarted so that the frequency hypotheses that are more likely to occur are searched again with the added sensitivity.

The following pseudo-code may be performed by an electronic device and illustrates one or more of the steps of FIG. 3, according to an embodiment:

```
for s in V
  for f in F(s)
    for r in R
      c = compute_correlation(s, f, r);
      if (c > min_correlation(L))
        L=replace_hypothesis(c,s,f,r,L);
        if (early_termination(L))
          exit_search;
        end
      end
    end
  end
end
```

Referring to the pseudo-code, above, the outermost For loop iterates through satellites in view V. The second For loop iterates through prioritized frequency offsets F for each satellite. The innermost For loop iterates through the synchronization rasters R.

For each combination of satellite s, frequency f, and raster r, the system computes a correlation value c using the “compute_correlation” function.

If the correlation value is above a specified minimum threshold (min_correlation), the system updates the list of hypotheses L with the new hypothesis.

The “early_termination” function assesses whether any hypothesis in L is likely to be correct, and if so, it triggers an exit from the search process.

The implementation of “early_termination” may vary depending on the system requirements and can be designed to operate periodically or under specific conditions.

The electronic device that performs one or more of the steps of FIG. 3 may be a UE, server, satellite, or another network device. Furthermore, the electronic device may include components, such as memory and one or more controllers capable of executing instructions stored in the memory to perform one or more of the steps of FIG. 3.

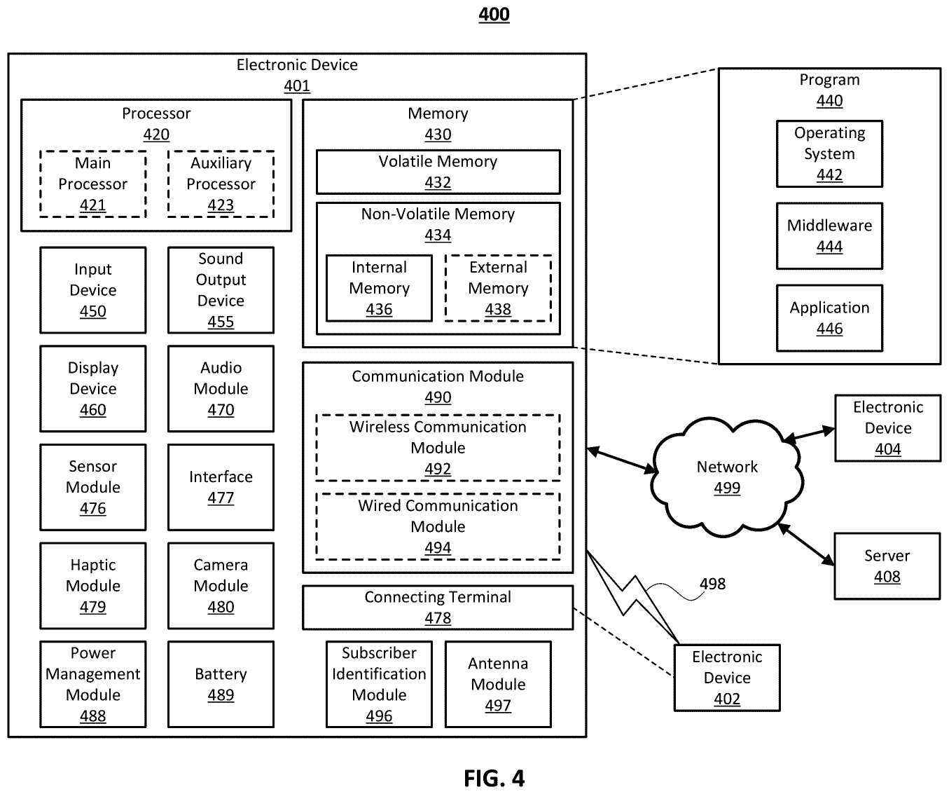

FIG. 4 is a block diagram of an electronic device in a network environment, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 440, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 446 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a GNSS communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, WiFi direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for improving cell searching in a non-terrestrial network (NTN), comprising:
obtaining almanac information,
obtaining position, velocity or time (PVT) information, and
generating a list of one or more satellites in view based on the almanac information and the PVT information.

2. The method of claim 1, wherein obtaining the almanac information further comprises downloading the almanac information when connected to a network and a prior set of almanac information has not been obtained or when a time elapsed since obtaining the prior set of almanac information is greater than or equal to a predetermined time duration.

3. The method of claim 1, wherein obtaining the almanac information further comprises compiling satellite ephemeris information to generate the almanac information.

4. The method of claim 1, wherein generating the list further comprises:
calculating an elevation angle of the one or more satellites, and
adding the one or more satellites to the list when the elevation angle is greater than or equal to a predefined elevation mask.

5. The method of claim 1, wherein generating the list further comprises:
determining one or more doppler shifts of the one or more satellites in view,
generating a prioritized frequency list of the one or more satellites in view based on the doppler shifts, and
searching one or more transmission frequencies based on the prioritized frequency list.

6. The method of claim 1, further comprising:
determining whether a correlation value of the one or more satellites in view is greater than or equal to a predetermined threshold, and
performing an early termination if the correlation value is greater than or equal to the predetermined threshold.

7. The method of claim 6, further comprising:
continuing searching frequency bands of the one or more satellites in the list if the correlation value is less than the predetermined threshold.

8. The method of claim 6, wherein the correlation value comprises a plurality of correlation values for one or more hypothesis of the one or more satellites in view.

9. The method of claim 6, wherein performing the early termination further comprises:
determining whether encoded data of the one or more satellites in view is successfully decoded based on a structure of the encoded data by checking at least one of parity information, a cyclic redundancy check (CRC), and another error detection property, and
performing the early termination if it is determined that the encoded data is successfully decoded.

10. The method of claim 1, further comprising:
calculating a ratio based on a highest correlation value in the list and a function of one or more correlation values in the list besides the highest correlation value for the one or more satellites in view, and
determining whether the ratio is greater than or equal to a predetermined threshold.

11. An electronic device comprising:
a non-transitory storage device storing instructions, and
a processor configured to execute the instructions, causing the electronic device to:
obtain almanac information,
obtain position, velocity or time (PVT) information, and
generate a list of one or more satellites in view based on the almanac information and the PVT information.

12. The electronic device of claim 11, wherein obtaining the almanac information further comprises downloading the almanac information when connected to a network and a prior set of almanac information has not been obtained or if a time elapsed since obtaining the prior set of almanac information is greater than or equal to a predetermined time duration.

13. The electronic device of claim 11, wherein obtaining the almanac information further comprises compiling satellite ephemeris information to generate the almanac information.

14. The electronic device of claim 11, wherein generating the list further comprises:
calculating an elevation angle of the one or more satellites, and
adding the one or more satellites to the list when the elevation angle is greater than or equal to a predefined elevation mask.

15. The electronic device of claim 11, wherein generating the list further comprises:
determining one or more doppler shifts of the one or more satellites in view,
generating a prioritized frequency list of the one or more satellites in view based on the doppler shifts, and
searching one or more transmission frequencies based on the prioritized frequency list.

16. The electronic device of claim 11, wherein the instructions are further configured to cause the processor to:
determine whether a correlation value of the one or more satellites in view is greater than or equal to a predetermined threshold, and
perform an early termination if the correlation value is greater than or equal to the predetermined threshold.

17. The electronic device of claim 16, wherein the instructions are further configured to cause the processor to:
continue searching frequency bands of the one or more satellites in the list if the correlation value is less than the predetermined threshold.

18. The electronic device of claim 16, wherein the correlation value comprises a plurality of correlation values for one or more hypothesis of the one or more satellites in view.

19. The electronic device of claim 16, wherein performing the early termination further comprises:
determining whether encoded data of the one or more satellites in view is successfully decoded based on a structure of the encoded data by checking at least one of parity information, a cyclic redundancy check (CRC), and another error detection property, and
performing the early termination if it is determined that the encoded data is successfully decoded.

20. The electronic device of claim 11, wherein the instructions are further configured to cause the processor to:
calculate a ratio based on a highest correlation value in the list and a function of one or more correlation values in the list besides the highest correlation value for the one or more satellites in view, and
determine whether the ratio is greater than or equal to a predetermined threshold.
